(19) United States
(12) Patent Application Publication
(10) Pub. No.: US 2026/0169331 A1
(43) Pub. Date: Jun. 18, 2026

(54) OPTICAL METASURFACE STRUCTURE AND MANUFACTURING METHOD THEREOF

(71) Applicant: UNITED MICROELECTRONICS CORP., Hsin-Chu City (TW)

(72) Inventors: Da-Jun Lin, Kaohsiung City (TW); Chin-Chia Yang, Tainan City (TW); Fu-Yu Tsai, Tainan City (TW); Bin-Siang Tsai, Changhua County (TW)

(73) Assignee: UNITED MICROELECTRONICS CORP., Hsin-Chu City (TW)

(21) Appl. No.: 19/021,129

(22) Filed: Jan. 14, 2025

(30) Foreign Application Priority Data
Dec. 16, 2024 (TW) 113148869

(51) Int. Cl. G02F 1/1345; B82Y 20/00; G02F 1/1343

(52) U.S. Cl. CPC G02F 1/13458; B82Y 20/00; G02F 1/134318; G02F 2202/36

(57) ABSTRACT

An optical metasurface structure includes a substrate, metal rail structures, and a liquid crystal material. The substrate includes a first region and a second region. The metal rail structures and the liquid crystal material are disposed above the first region. At least a part of the liquid crystal material is located between the metal rail structures adjacent to each other in a horizontal direction, and a top width of one of the metal rail structures is less than a bottom width of the one of the metal rail structures.

### BACKGROUND OF THE INVENTION

### 1. Field Of The Invention

The present invention relates to an optical metasurface structure and a manufacturing method thereof, and more particularly, to an optical metasurface structure including metal rail structures and a manufacturing method thereof.

### 2. Description Of The Prior Art

Optical metasurfaces may be used to change many properties (such as amplitude, phase and/or polarization conditions) of incident radiation (such as incident light), and various specific functions (such as light beam control, focusing, spectral filtering, and so forth) may be realized accordingly. By combining the design of liquid crystal materials and applied voltage conditions, tunable optical metasurfaces can be realized, and the applications of the optical metasurfaces may be increased accordingly.

### SUMMARY OF THE INVENTION

An optical metasurface structure and a manufacturing method thereof are provided in the present invention. A combination of a metal rail structure with a top width less than a bottom width and a liquid crystal material may be used to realize a tunable optical metasurface structure.

According to an embodiment of the present invention, an optical metasurface structure is provided. The optical metasurface structure includes a substrate, metal rail structures, and a liquid crystal material. The substrate includes a first region and a second region. The metal rail structures and the liquid crystal material are disposed above the first region. At least a part of the liquid crystal material is located between the metal rail structures adjacent to each other in a horizontal direction, and a top width of one of the metal rail structures is less than a bottom width of the one of the metal rail structures.

According to an embodiment of the present invention, a manufacturing method of an optical metasurface structure is provided. The manufacturing method includes the following steps. A substrate is provided, and the substrate includes a first region and a second region. Metal rail structures are formed above the first region, and a liquid crystal material is formed above the first region. At least a part of the liquid crystal material is located between the metal rail structures adjacent to each other in a horizontal direction, and a top width of one of the metal rail structures is less than a bottom width of the one of the metal rail structures.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing illustrating an optical metasurface structure according to a first embodiment of the present invention.

FIG. 2 is a schematic drawing illustrating an operation condition of an optical metasurface structure according to an embodiment of the present invention.

FIGS. 3-9 are schematic drawings illustrating a manufacturing method of the optical metasurface structure according to the first embodiment of the present invention, wherein FIG. 4 is a schematic drawing in a step subsequent to FIG. 3, FIG. 5 is a schematic drawing in a step subsequent to FIG. 4, FIG. 6 is a schematic drawing in a step subsequent to FIG. 5, FIG. 7 is a schematic drawing in a step subsequent to FIG. 6, FIG. 8 is a schematic drawing in a step subsequent to FIG. 7, and FIG. 9 is a schematic drawing in a step subsequent to FIG. 8.

FIG. 10 is a schematic drawing illustrating an optical metasurface structure according to a second embodiment of the present invention.

FIG. 11 is a schematic drawing illustrating a manufacturing method of the optical metasurface structure according to the second embodiment of the present invention.

FIG. 12 is a schematic drawing illustrating an optical metasurface structure according to a third embodiment of the present invention.

FIGS. 13 and 14 are schematic drawings illustrating a manufacturing method of the optical metasurface structure according to the third embodiment of the present invention, wherein FIG. 14 is a schematic drawing in a step subsequent to FIG. 13.

FIG. 15 is a schematic drawing illustrating an optical metasurface structure according to a fourth embodiment of the present invention.

### DETAILED DESCRIPTION

The present invention has been particularly shown and described with respect to certain embodiments and specific features thereof. The embodiments set forth herein below are to be taken as illustrative rather than limiting. It should be readily apparent to those of ordinary skill in the art that various changes and modifications in form and detail may be made without departing from the spirit and scope of the present invention.

Before the further description of the preferred embodiment, the specific terms used throughout the text will be described below.

The terms “on,” “above,” and “over” used herein should be interpreted in the broadest manner such that “on” not only means “directly on” something but also includes the meaning of “on” something with an intermediate feature or a layer therebetween, and that “above” or “over” not only means the meaning of “above” or “over” something but can also include the meaning it is “above” or “over” something with no intermediate feature or layer therebetween (i.e., directly on something).

The ordinal numbers, such as “first”, “second”, etc., used in the description and the claims are used to modify the elements in the claims and do not themselves imply and represent that the claim has any previous ordinal number, do not represent the sequence of some claimed element and another claimed element, and do not represent the sequence of the manufacturing methods, unless an addition description is accompanied. The use of these ordinal numbers is only used to make a claimed element with a certain name clear from another claimed element with the same name.

The term “etch” is used herein to describe the process of patterning a material layer so that at least a portion of the material layer after etching is retained. When “etching” a material layer, at least a portion of the material layer is retained after the end of the treatment. In contrast, when the material layer is “removed”, substantially all the material layer is removed in the process. However, in some embodiments, “removal” is considered to be a broad term and may include etching.

The term “forming” or the term “disposing” are used hereinafter to describe the behavior of applying a layer of material to the substrate. Such terms are intended to describe any possible layer forming techniques including, but not limited to, thermal growth, sputtering, evaporation, chemical vapor deposition, epitaxial growth, electroplating, and the like.

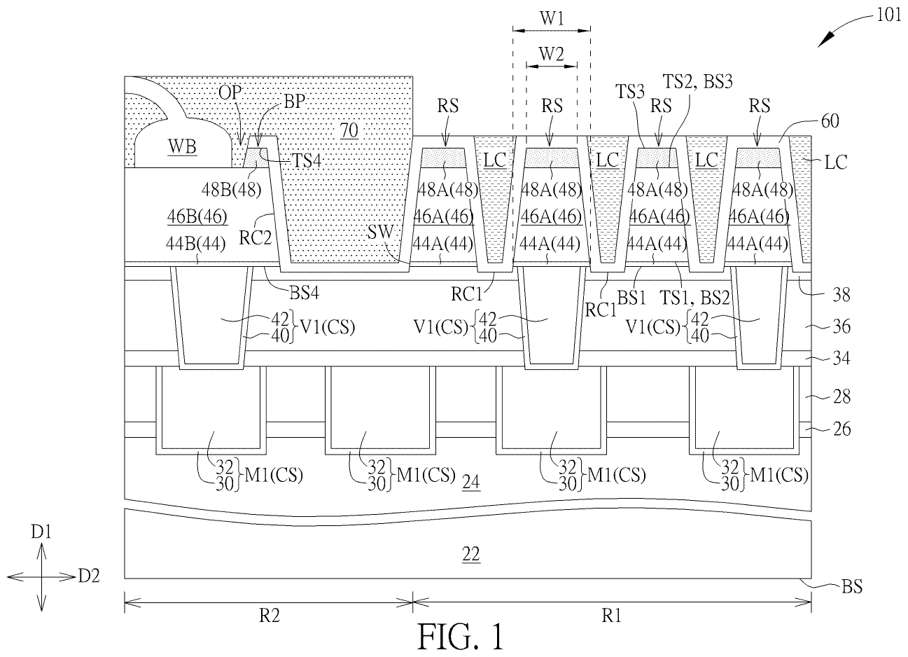

Please refer to FIG. 1. FIG. 1 is a schematic drawing illustrating an optical metasurface structure 101 according to a first embodiment of the present invention. As shown in FIG. 1, the optical metasurface structure 101 includes a substrate 22, metal rail structures RS, and a liquid crystal material LC. The substrate 22 includes a first region R1 and a second region R2. The metal rail structures RS and the liquid crystal material LC are disposed above the first region R1. At least a part of the liquid crystal material LC is located between the metal rail structures RS adjacent to each other in a horizontal direction D2, and a top width (such as a width W2) of at least one of the metal rail structures RS is less than a bottom width (such as a width W1) of the at least one of the metal rail structures RS. In some embodiments, the top width of each of the metal rail structures RS may be less than the bottom width of this metal rail structure RS. The combination of the metal rail structure RS with the top width less than the bottom width and the liquid crystal material may be used to realize a tunable optical metasurface structure.

In some embodiments, a vertical direction D1 may be regarded as a thickness direction of the substrate 22, the substrate may have a top surface and a bottom surface BS opposite to the top surface in the vertical direction D1, and the metal rail structures RS and the liquid crystal material LC described above may be disposed at the side of the top surface. A horizontal direction substantially orthogonal to the vertical direction D1 (such as the horizontal direction D2 and other directions orthogonal to the vertical direction D1) may be substantially parallel with the top surface and/or the bottom surface BS of the substrate 22, but not limited thereto. In this description, a distance between the bottom surface BS of the substrate 22 and a relatively higher location and/or a relatively higher part in the vertical direction D1 may be greater than a distance between the bottom surface BS of the substrate 22 and a relatively lower location and/or a relatively lower part in the vertical direction D1. The bottom or a lower portion of each component may be closer to the bottom surface BS of the substrate 22 in the vertical direction D1 than the top or upper portion of this component. Another component disposed above a specific component may be regarded as being relatively far from the bottom surface BS of the substrate 22 in the vertical direction D1, and another component disposed under a specific component may be regarded as being relatively close to the bottom surface BS of the substrate 22 in the vertical direction D1. Additionally, in this description, a top surface and a top portion of a specific component may include but is not limited to the topmost surface and the topmost portion of this component in the vertical direction D1, and a bottom surface and a bottom portion of a specific component may include but is not limited to the bottommost surface and the bottommost portion of this component in the vertical direction D1. In this description, the condition that a certain component is disposed between two other components in a specific direction may include but is not limited to a condition that the certain component is sandwiched between the two other components in the specific direction.

In some embodiments, the substrate 22 may include a silicon substrate or a substrate made of other suitable semiconductor materials or non-semiconductor materials. In addition, the first region R1 and the second region R2 of the substrate 22 may be regarded as a metal rail region and a peripheral bonding region, respectively, but not limited thereto. In some embodiments, the optical metasurface structure 101 may further include a bonding pad BP, a dielectric layer (such as a dielectric layer 24, an etching stop layer 26, a dielectric layer 28, an etching stop layer 34, a dielectric layer 36, and/or an etching stop layer 38), and a connection structure CS. The bonding pad BP is disposed above the second region R2, and a material composition of the bonding pad BP may be identical to a material composition of each of the metal rail structures RS. The dielectric layer 24, the etching stop layer 26, the dielectric layer 28, the etching stop layer 34, the dielectric layer 36, and the etching stop layer 38 may be disposed and stacked sequentially above the first region R1 and the second region R2 of the substrate 22, and the connection structure CS may be disposed in the dielectric layer 24, the etching stop layer 26, the dielectric layer 28, the etching stop layer 34, the dielectric layer 36, and the etching stop layer 38. The dielectric layer 24, the dielectric layer 28, and the dielectric layer 36 may respectively include an oxide dielectric material (such as silicon oxide) or other suitable dielectric materials, and the etching stop layer 26, the etching stop layer 34, and the etching stop layer 38 may respectively include a nitride dielectric material, a carbide dielectric material (such as nitrogen doped carbide (NDC)) or other suitable dielectric materials.

In some embodiments, the connection structure CS may include a plurality of electrically conductive lines M1 and a plurality of via conductors V1. Each of the electrically conductive lines M1 may be disposed in the dielectric layer 24, the etching stop layer 26, and the dielectric layer 28, and each of the via conductors V1 may be disposed in the etching stop layer 34, the dielectric layer 36, and the etching stop layer 38. Each of the via conductors V1 may be disposed on and directly contact the corresponding electrically conductive line M1 in the vertical direction D1 for being electrically connected with the corresponding electrically conductive line M1. The bonding pad BP and the metal rail structures RS may be disposed above the dielectric layer (such as the dielectric layer 24, the etching stop layer 26, the dielectric layer 28, the etching stop layer 34, the dielectric layer 36, and the etching stop layer 38) and the connection structure CS in the vertical direction D1, and the bonding pad BP may be electrically connected with at least one of the metal rail structures RS via the connection structure CS. In some embodiments, each of the electrically conductive lines M1 may include a barrier layer 30 and an electrically conductive material 32 disposed on the barrier layer 30, and the via conductor V1 may include a barrier layer 40 and an electrically conductive material 42 disposed on the barrier layer 40, but not limited thereto. The barrier layer 30 and the barrier layer 40 may respectively include titanium, titanium nitride, tantalum, tantalum nitride, or other suitable electrically conductive barrier materials, and the electrically conductive material 32 and the electrically conductive material 42 may respectively include a material with relatively low electrical resistivity, such as copper, aluminum, tungsten, and so forth.

In some embodiments, active components (such as transistors, diodes and so forth), passive components (such as capacitors, resistors and so forth), and/or other related circuits (not illustrated) may be disposed on the substrate 22 according to some design considerations, the bonding pad BP and/or the metal rail structure RS may be electrically connected with the components and/or the circuits described above via the connection structure CS, and the electric potential of each metal rail structure RS may be controlled by specific component and/or circuit, but not limited thereto. In some embodiments, the material composition of the dielectric layer 24 and the material composition of the substrate 22 may be the same, the dielectric layer 24 and the substrate 22 may be regarded together as one substrate structure, and there is not any above-mentioned component and/or circuit disposed in the dielectric layer 24 and the substrate 22. A plurality of the bonding pads BP may be disposed above the second region R2, and each of the bonding pads BP may be electrically connected with the corresponding metal rail structure RS via the connection structure CS for controlling the electric potential of each of the metal rail structures RS.

In some embodiments, each of the metal rail structures RS may include a first barrier pattern 44A, a first copper pattern 46A, and a first metal mask pattern 48A disposed and stacked sequentially in the vertical direction D1, and the bonding pad BP may include a second barrier pattern 44B, a second copper pattern 46B, and a second metal mask pattern 48B disposed and stacked sequentially in the vertical direction D1. The first copper pattern 46A is disposed on the first barrier pattern 44A, the second copper pattern 46B is disposed on the second barrier pattern 44B, the first metal mask pattern 48A is disposed on the first copper pattern 46A, and the second metal mask pattern 48B is disposed on the second copper pattern 46B. In some embodiments, the first copper pattern 46A may directly contact the first barrier pattern 44A and the first metal mask pattern 48A, respectively, and the second copper pattern 46B may directly contact the second barrier pattern 44B and the second metal mask pattern 48B, respectively, but not limited thereto. In addition, the first barrier pattern 44A and the second barrier pattern 44B may be different portions in a patterned barrier layer 44 and separated from each other, and the material composition of the first barrier pattern 44A and the material composition of the second barrier pattern 44B may be the same accordingly. The first copper pattern 46A and the second copper pattern 46B may be different portions in a patterned copper layer 46 and separated from each other, and the material composition of the first copper pattern 46A and the material composition of the second copper pattern 46B may be the same accordingly. The first metal mask pattern 48A and the second metal mask pattern 48B may be different portions in a patterned metal mask layer 48 and separated from each other, and the material composition of the first metal mask pattern 48A and the material composition of the second metal mask pattern 48B may be the same accordingly. In some embodiments, the patterned barrier layer 44 may include tantalum, tantalum nitride, or other suitable electrically conductive barrier materials, the patterned copper layer 46 may consist of copper, and the patterned metal mask layer 48 may include titanium nitride, tantalum nitride, aluminum, or other suitable metal mask materials.

In some embodiments, each of the metal rail structures RS may have a trapezoid structure that is narrow at the top and wide at the bottom in a cross-sectional diagram of the optical metasurface structure 101 (such as FIG. 1), a width of each of the metal rail structures RS may gradually and/or continuously increase from a top surface (such as a top surface TS3) to a bottom surface BS1, and the first barrier pattern 44A, the first copper pattern 46A, and the first metal mask pattern 48A in each of the metal rail structures RS may respectively have a trapezoid structure that is narrow at the top and wide at the bottom in the cross-sectional diagram of the optical metasurface structure 101 also, but not limited thereto. Therefore, a top width of each of the first metal mask pattern 48A (such as a length of the top surface TS3 in the horizontal direction D2) may be less than a bottom width of the same first metal mask pattern 48A (such as a length of a bottom surface BS3 in the horizontal direction D2), a top width of each of the first copper pattern 46A (such as a length of a top surface TS2 in the horizontal direction D2) may be less than a bottom width of the same first copper pattern 46A (such as a length of a bottom surface BS2 in the horizontal direction D2), and a top width of each of the first barrier pattern 44A (such as a length of a top surface TS1 in the horizontal direction D2) may be less than a bottom width of the same first barrier pattern 44A (such as a length of the bottom surface BS1 in the horizontal direction D2). In some embodiments, at least a part of each of the metal rail structures RS may substantially extend in another horizontal direction (such as a horizontal direction orthogonal to the horizontal direction D2 and the vertical direction D1, respectively), and a length of each of the metal rail structures RS in the horizontal direction D2 may be regarded as the width described above, but not limited thereto. In addition, a bottom surface of the bonding pad BP (such as a bottom surface BS4) and a bottom surface of each of the metal rail structures RS (such as the bottom surface BS1) may be substantially coplanar, and a top surface of the bonding pad BP (such as a top surface TS4) and a top surface of each of the metal rail structures TS (such as the top surface TS3) may be substantially coplanar. In some embodiments, the bottom width of each of the metal rail structures RS (such as the width W1) may be greater than a top width of the corresponding via conductor V1 for avoiding or reducing negative influence of the manufacturing process of forming the metal rail structures RS on the via conductors V1.

In some embodiments, the optical metasurface structure 101 may further include a dielectric cap layer 60 disposed on the metal rail structures RS and the bonding pad BP. The dielectric cap layer 60 may cover the top surface and a sidewall of each of the metal rail structures RS and the top surface and a sidewall of the bonding pad BP, and a part of the dielectric cap layer 60 may be sandwiched between the liquid crystal material LC and each of the metal rail structures RS. A portion of the dielectric cap layer 60 may be disposed on and directly contact a sidewall of the first barrier pattern 44A (such as a sidewall SW), a sidewall of the first copper pattern 46A, and a sidewall and a top surface TS3 of the first metal mask pattern 48A in each of the metal rail structures RS. Another portion of the dielectric cap layer 60 may be disposed on and directly contact a sidewall of the second barrier pattern 44B, a sidewall of the second copper pattern 46B, and a sidewall and the top surface TS4 of the second metal mask pattern 48B of the bonding pad BP. The dielectric cap layer 60 may include silicon nitride or other suitable dielectric materials. In some embodiments, the optical metasurface structure 101 may further include an opening OP, a copper bonding wire WB, and a packaging material 70. The opening OP may penetrate through the dielectric cap layer 60 on the bonding pad BP and the second metal mask pattern 48B in the bonding pad BP for exposing the second copper pattern 46B in the bonding pad BP. The copper bonding wire WB may be partly disposed in the opening and directly connected with the second copper pattern 46B. The packaging material 70 may be disposed above the second region R2 and cover the dielectric cap layer 60, the bonding pad BP, and the copper bonding wire WB. The package material 70 may include epoxy or other suitable materials.

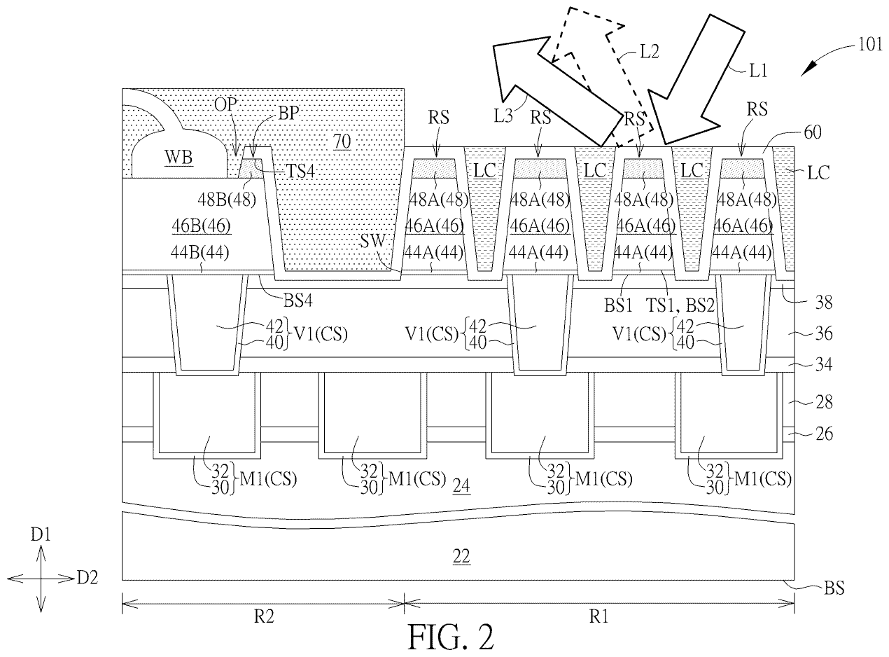

Please refer to FIG. 2. FIG. 2 is a schematic drawing illustrating an operation condition of the optical metasurface structure according to an embodiment of the present invention. As shown in FIG. 2, in some embodiments, the arrangement of liquid crystal molecules in the liquid crystal material LC may be controlled by adjusting the voltage applied to each metal rail structure RS, so as to alter the angle of reflected light when the metal rail structures and the liquid crystal material LC reflect incident light. For example, when a first voltage difference exists between adjacent metal rail structures RS, incident light (such as light L1) may be reflected and become light L2, and when a second voltage difference exists between adjacent metal rail structures RS by changing the voltage applied to the metal rail structures RS, the incident light (such as the light L1) may be reflected and become light L3 with a larger reflection angle, but not limited thereto. By adjusting voltage applied to each of the metal rail structures RS, the optical metasurface structure in the present invention may be capable of reflecting incident light with different angles into the same specific angle and/or reflecting incident light with a specific angle into different angles, and the optical metasurface structure in the present invention may be regarded as a tunable optical metasurface structure accordingly. In some embodiments, the optical metasurface structure in the present invention may be applied in a LiDAR structure and used with a detection light emitter (such as an infrared laser emitter, but not limited thereto) to reflect the detection light into multiple light rays with different emission angles for increasing the angle range of the detection light emitted from the LiDAR structure, and the optical metasurface structure may also be used with a detection light receiver for reflecting light received from different angles to a fixed position of the detection light receiver. In some embodiments, the area of the electrically conductive lines M1 and/or the area of a metal electrically conductive pattern (not illustrated) located at the same level of the electrically conductive lines M1 may be modified for enhancing the reflection effect of the optical metasurface structure on specific light. In addition, the width, the height, and the length of each of the metal rail structures RS and the spacing between the metal rail structures RS may be modified according to the wavelength range of the corresponding operation light for generating the desired resonance effect. For example, the spacing between metal rail structures RS may be less than the wavelength of the operation light, but not limited thereto.

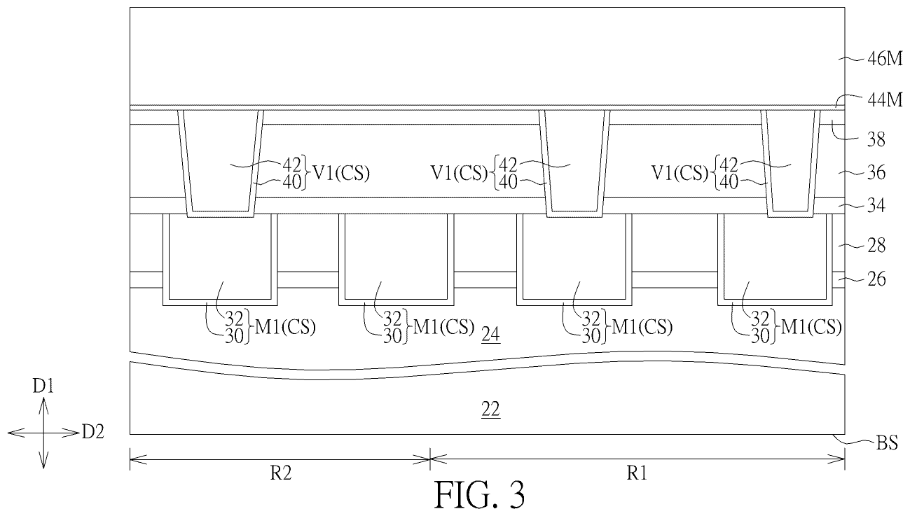

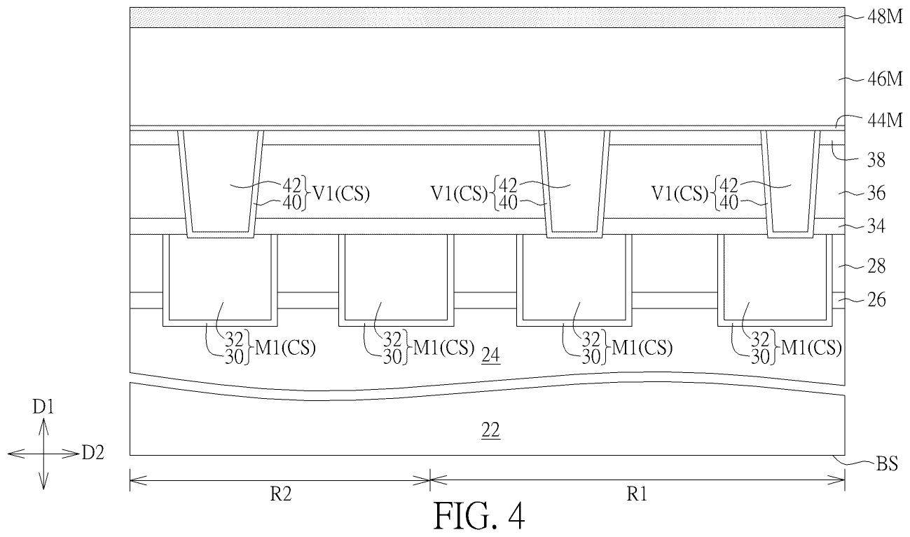

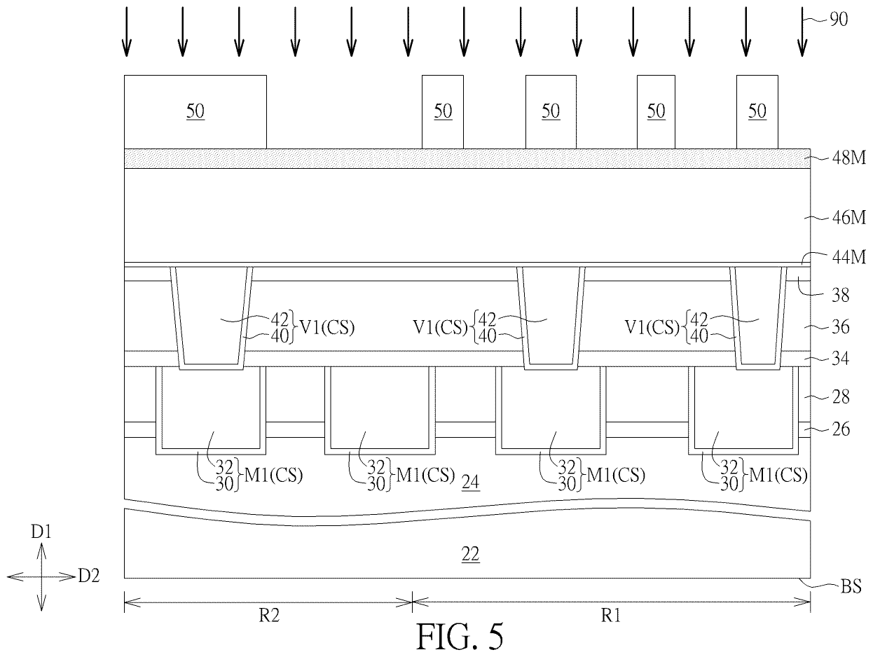

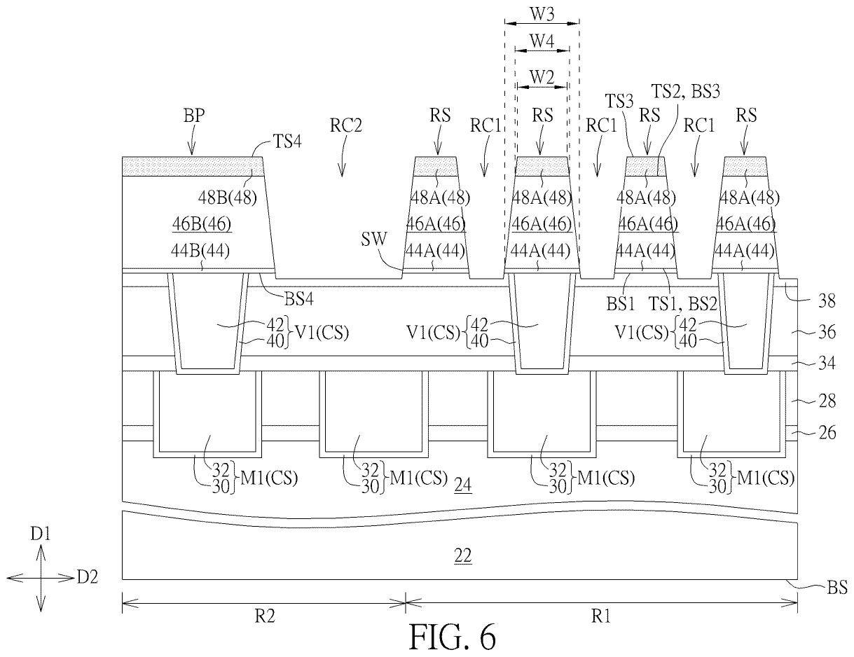

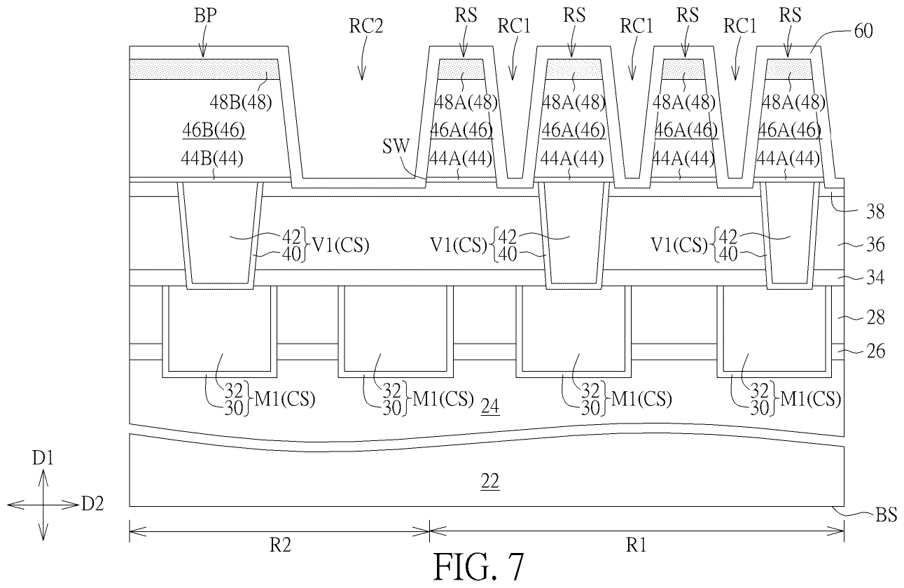

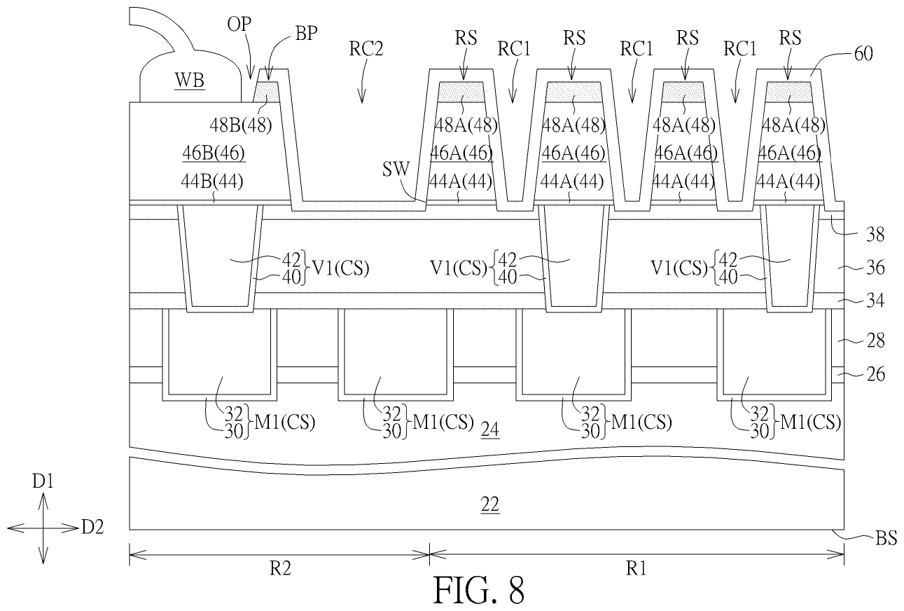

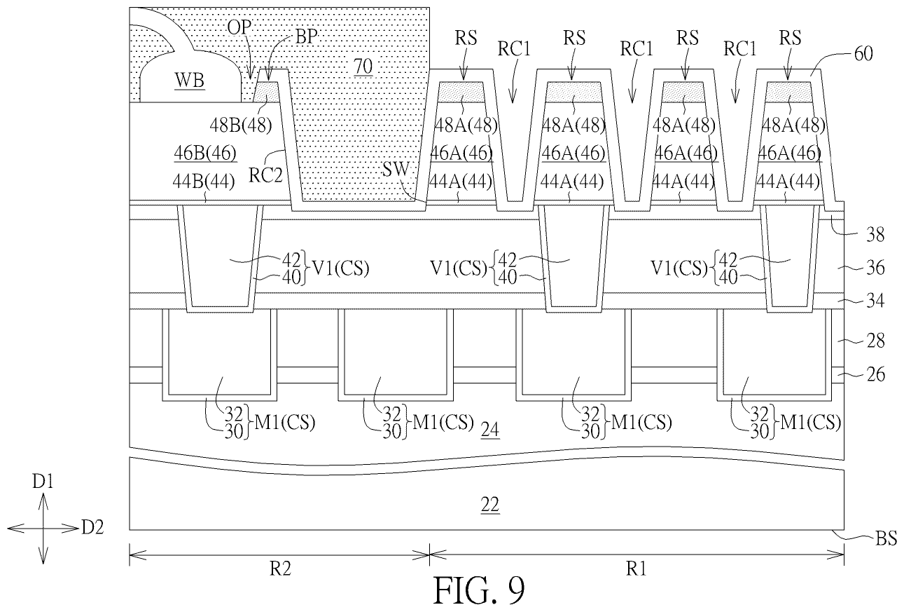

Please refer to FIG. 1 and FIGS. 3-9. FIGS. 3-9 are schematic drawings illustrating a manufacturing method of the optical metasurface structure according to the first embodiment of the present invention, wherein FIG. 4 is a schematic drawing in a step subsequent to FIG. 3, FIG. 5 is a schematic drawing in a step subsequent to FIG. 4, FIG. 6 is a schematic drawing in a step subsequent to FIG. 5, FIG. 7 is a schematic drawing in a step subsequent to FIG. 6, FIG. 8 is a schematic drawing in a step subsequent to FIG. 7, and FIG. 9 is a schematic drawing in a step subsequent to FIG. 8. In some embodiments, FIG. 1 may be regarded as a schematic drawing in a step subsequent to FIG. 9, but not limited thereto. As shown in FIG. 1, the manufacturing method in this embodiment includes the following steps. Firstly, the substrate 22 is provided, and the substrate 22 includes the first region R1 and the second region R2. The metal rail structures RS are formed above the first region R1, and the liquid crystal material LC is formed above the first region R2. At least a part of the liquid crystal material LC is located between the metal rail structures RS adjacent to each other in the horizontal direction D2, and the top width (such as the width W2) of at least one of the metal rail structures RS is less than the bottom width (such as the width W1) of the at least one of the metal rail structures RS.

Specifically, the manufacturing method in this embodiment may include but is not limited to the following steps. As shown in FIG. 3, before the metal rail structures and the bonding pad described above are formed, the dielectric layer (such as the dielectric layer 24, the etching stop layer 26, the dielectric layer 28, the etching stop layer 34, the dielectric layer 36, and/or the etching stop layer 38) may be formed on the first region R1 and the second region R2 of the substrate 22, and the connection structure CS may be formed in the dielectric layer. After the dielectric layer and the connection structure CS are formed, a barrier material layer 44M and a copper layer 46M may be sequentially formed on the first region R1 and the second region R2 of the substrate 22. The barrier material layer 44M may be formed on top surfaces of the etching stop layer 38 and the via conductors V1, and the copper layer 46M may be formed on the barrier material layer 44M. In some embodiments, the copper layer 46M may be formed by forming a copper material on the barrier material layer 44M via an electrochemical plating (ECP) process or other suitable processes and performing a planarization process to this copper material, but not limited thereto. Subsequently, as shown in FIG. 4, a metal mask layer 48M may be formed on the copper layer 46M, and the metal mask layer 48M may be partly located above the first region R1 and partly located above the second region R2 in the vertical direction D1. As shown in FIG. 4 and FIG. 5, after the metal mask layer 48M is formed, a patterned mask layer 50 may be formed on the metal mask layer 48M, and a patterning process 90 using the patterned mask layer 50 as a mask may be performed. The patterned mask layer 50 may include photoresist or other suitable mask materials, and the patterning process 90 may include an ion beam etching (IBE) process or other suitable patterning approaches.

As shown in FIG. 5 and FIG. 6, the patterned mask layer 50 may be removed after the patterning process 90, the metal mask layer 48M may be patterned to be the patterned metal mask layer 48 by the patterning process 90, the copper layer 46M may be patterned to be the patterned copper layer 46 by the patterning process 90, and the barrier material layer 44M may be patterned to be the patterned barrier layer 44 by the patterning process 90. The patterned metal mask layer 48 may include a plurality of the first metal mask patterns 48A located above the first region R1 and the second metal mask pattern 48B located above the second region R2, the patterned copper layer 46 may include a plurality of the first copper patterns 46A located above the first region R1 and the second copper pattern 46B located above the second region R2, and the patterned barrier layer 44 may include a plurality of the first barrier patterns 44A located above the first region R1 and the second barrier pattern 44B located above the second region R2. Each of the metal rail structures RS may include one of the first metal mask patterns 48A, one of the first copper patterns 46A, and one of the first barrier patterns 44A, and the bonding pad BP may include the second metal mask pattern 48B, the second copper pattern 46B, and the second barrier pattern 44B. In some embodiments, at least a part of the metal mask layer 48M, the copper layer 46M, and the barrier material layer 44M without being covered by the patterned mask layer 50 in the vertical direction D1 may be removed by the patterning process 90 for generating a patterning result, and a part of the etching stop layer 38 may be removed by the patterning process 90 for forming a recess RC1 located between the metal rail structures RS adjacent to each other and a recess RC2 located between the bonding pad BP and the metal rail structure RS, but not limited thereto. In other words, a bottom of the recess RC1 (such as a top surface of the etching stop layer 38 located under the recess RC1) and a bottom of the recess RC2 (such as a top surface of the etching stop layer 38 located under the recess RC2) may be lower than a top surface of the etching stop layer 38 located under the metal rail structure RS and a top surface of the etching stop layer 38 located under the bonding pad BP in the vertical direction.

The metal rail structures RS and the bonding pad BP may be formed above the first region R1 and the second region R2, respectively, by the patterning process 90, the material composition of the bonding pad BP is identical to the material composition of each of the metal rail structures RS, and the bonding pad BP and the metal rail structures RS may be regarded as being formed concurrently by the same process. It is worth noting that, the method of forming the metal rail structures RS and the bonding pad BP may include but is not limited to the steps illustrated in FIGS. 3-6 described above, and the metal rail structures RS and the bonding pad BP shown in FIG. 6 may also be formed by other suitable approaches according to some design considerations. Because of the influence of the process characteristics of the patterning process 90 (such as the process characteristics of the IBE process), each of the metal rail structures RS may include a trapezoid structure that is narrow at the top and wide at the bottom in the cross-sectional diagram, the top width of each of the first metal mask patterns 48A (such as the width W2) may be less than the bottom width of the same first metal mask pattern 48A (such as a width W4), the top width of each of the first copper patterns 46A (such as the width W4) may be less than the bottom width of the same first copper pattern 46A (such as a width W3), and the top width of each of the first barrier patterns 44A may be less than the bottom width of the same first barrier pattern 44A, but not limited thereto. In addition, the metal rail structures RS and the bonding pad BP may be formed above the dielectric layer (such as the dielectric layer 24, the etching stop layer 26, the dielectric layer 28, the etching stop layer 34, the dielectric layer 36, and/or the etching stop layer 38) and the connection structure CS, and the bonding pad BP may be electrically connected with at least one of the metal rail structures RS via the connection structure CS.

Subsequently, as shown in FIG. 7, the dielectric cap layer 60 may be formed on the metal rail structures RS, the bonding pad BP, and the etching stop layer 38, and the dielectric cap layer 60 may be substantially formed conformally on and directly contact each of the metal rail structures RS, the bonding pad BP, and the etching stop layer 38. Therefore, the dielectric cap layer 60 may be partly formed in the recesses RC1 and the recess RC2 without fully filling the recesses RC1 and the recess RC2. As shown in FIG. 7 and FIG. 8, the opening OP may be formed, and the opening OP may penetrate through the dielectric cap layer 60 located on the bonding pad BP and the second metal mask pattern 48B in the vertical direction D1. Subsequently, the copper bonding wire WB may be formed on the bonding pad BP, at least a part of the copper bonding wire WB may be disposed in the opening OP, and the copper bonding wire WB may be directly connected with the second copper pattern 46B. The copper bonding wire WB may be connected with the second copper pattern 46B by a wire bonding approach. The contact resistance between the copper bonding wire WB and the bonding pad BP may be reduced because the material of the copper bonding wire WB and the material of the second copper pattern 46B are the same and the copper bonding wire WB directly contacts the second copper pattern 46B, and the operation of the optical metasurface structure may be improved accordingly. As shown in FIG. 9, the packaging material 70 may then be formed covering the dielectric cap layer 60, the bonding pad BP, and the copper bonding wire WB located above the second region R2 for protecting the bonding pad BP and the copper bonding wire WB. As shown in FIG. 9 and FIG. 1, after the packaging material 70 is formed, the liquid crystal material LC may be formed above the first region R1, and at least a part of the liquid crystal material LC may be formed in each of the recesses RC1 for forming the optical metasurface structure 101 illustrated in FIG. 1. The dielectric cap layer 60 is formed on the metal rail structures RS and the bonding pad BP before the liquid crystal material LC is formed, and a part of the dielectric cap layer 60 may be sandwiched between the liquid crystal material LC and each of the metal rail structures RS.

The following description will detail the different embodiments of the present invention. To simplify the description, the following description will detail the dissimilarities among different embodiments and the identical features will not be redundantly described. In addition, identical components in each of the following embodiments are marked with identical symbols for making it easier to understand the differences between the embodiments.

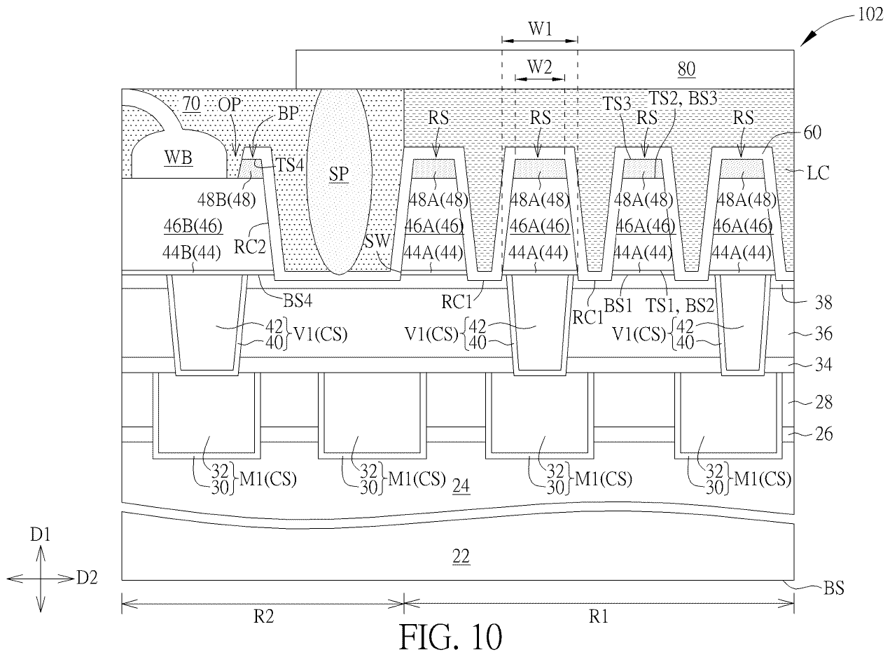

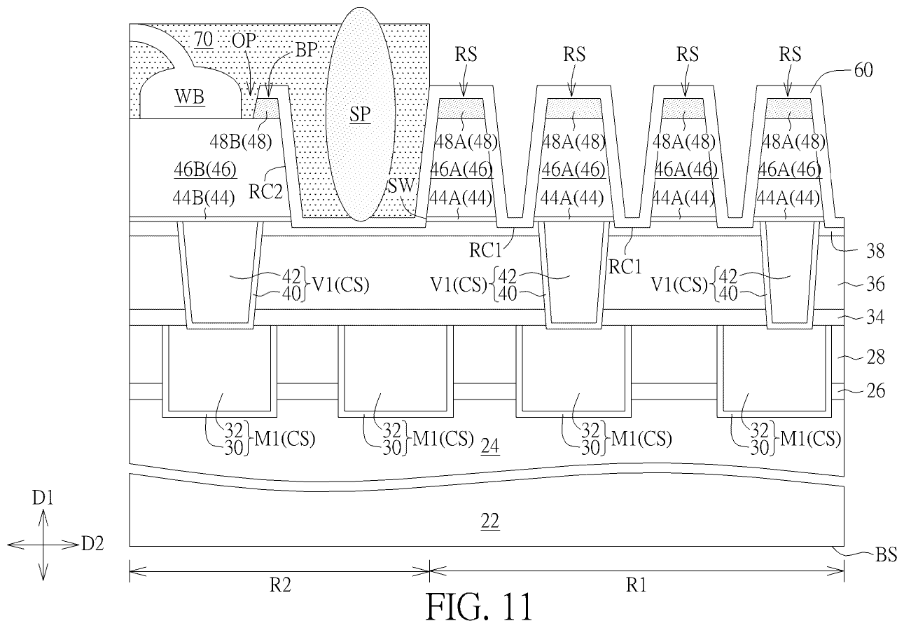

Please refer to FIG. 10 and FIG. 11. FIG. 10 is a schematic drawing illustrating an optical metasurface structure 102 according to a second embodiment of the present invention, and FIG. 11 is a schematic drawing illustrating a manufacturing method of the optical metasurface structure in this second embodiment. As shown in FIG. 10, the optical metasurface structure 102 may further include a spacer SP and a cover substrate 80. The spacer SP may be disposed above the second region R2 and located in the packaging material 70, and the cover substrate 80 may be partly located above the first region R1 and partly located above the second region R2. The cover substrate 80 may directly contact the liquid crystal material LC, the spacer SP, and the packaging material 70, and the space SP may be partly located in the recess RC2 and used to maintain a specific distant between the cover substrate 80 and each of the metal rail structures RS in the vertical direction D1. The spacer SP may be disposed mainly at points around the edges of the device and/or other specific positions for providing the supporting performance, and the height of the cover substrate 80 may be controlled by other approaches without disposing the spacer SP according to some design considerations in some embodiments. In some embodiments, the spacer SP may include an insulating engineer material, such as glass fiber microspheres, plastic microspheres, or silicone gaskets, but the material of the spacer SP is not limited to this. The cover substrate 80 may include a transparent substrate (such as a glass substrate, but not limited thereto) and a transparent electrically conductive layer (such as a transparent indium tin oxide layer, but not limited thereto) disposed on a side of the transparent substrate facing the liquid crystal material LC, and the transparent electrically conductive layer may be used as a common electrode controlling the condition of the liquid crystal material LC, but not limited thereto. In some embodiments, FIG. 10 may be regarded as a schematic drawing in a step subsequent to FIG. 11. As shown in FIG. 11 and FIG. 10, in the manufacturing method of this embodiment, the liquid crystal material LC and the cover substrate 80 may be formed after the packaging material 70 and the spacer SP are formed, and the cover substrate 80 does not cover the copper bonding wire WB in the vertical direction D1, but not limited thereto. It is worth noting that, the spacer SP and the cover substrate 80 in this embodiment may be applied to other embodiments of the present invention according to some design considerations.

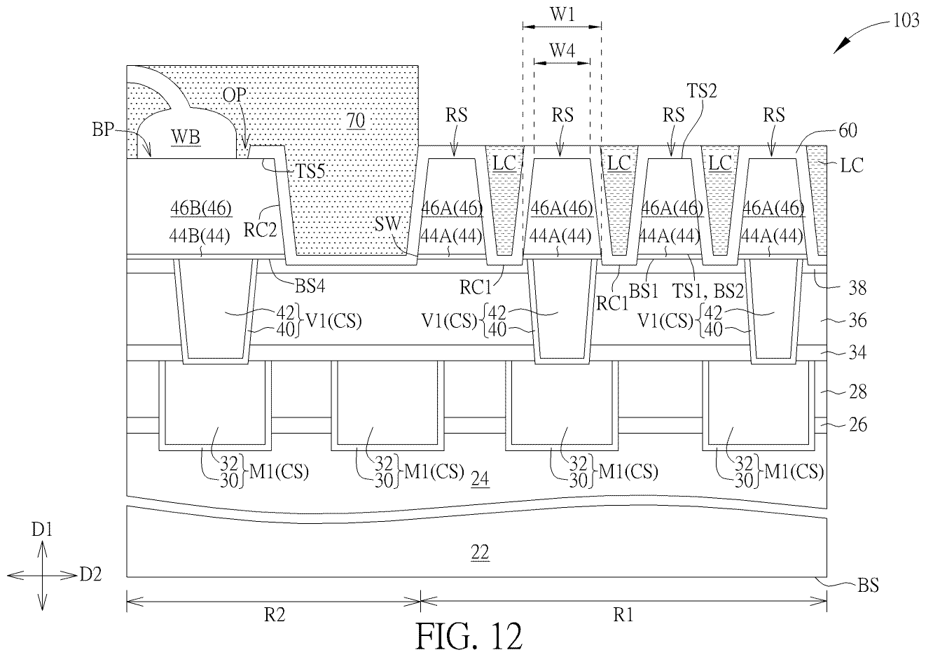

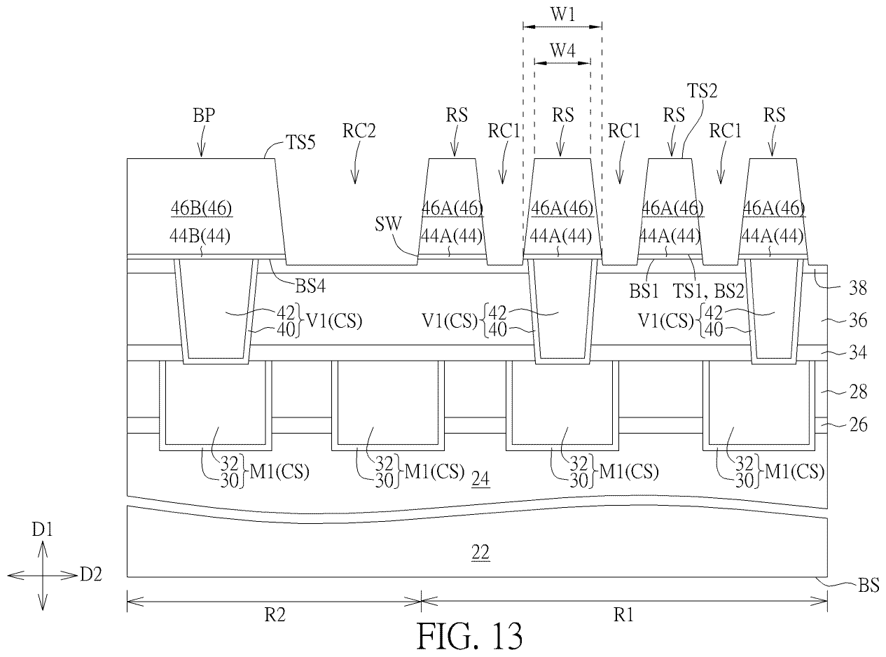

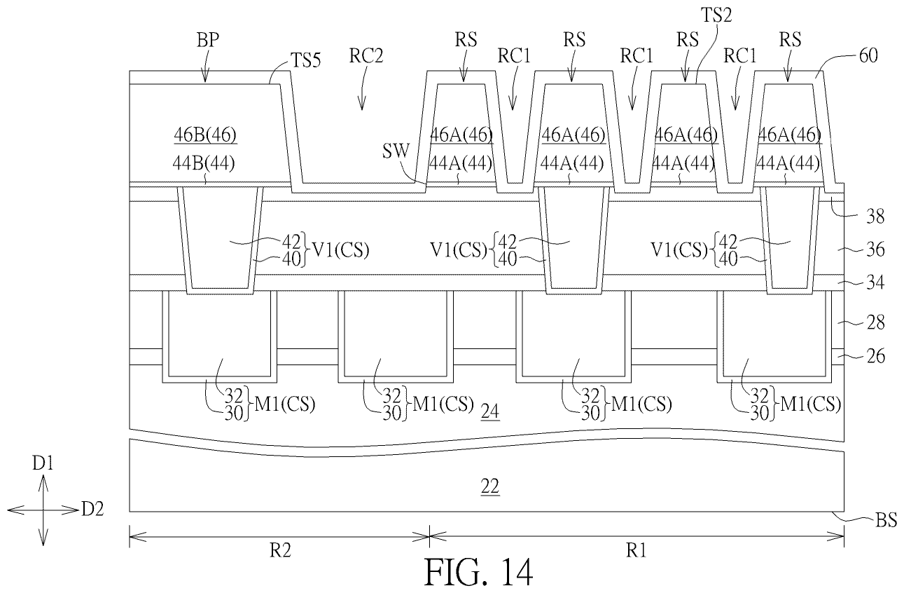

Please refer to FIGS. 12-14. FIG. 12 is a schematic drawing illustrating an optical metasurface structure 103 according to a third embodiment of the present invention, and FIGS. 13 and 14 are schematic drawings illustrating a manufacturing method of the optical metasurface structure in this embodiment, wherein FIG. 14 is a schematic drawing in a step subsequent to FIG. 13. In some embodiments, FIG. 12 may be regarded as a schematic drawing in a step subsequent to FIG. 14, but not limited thereto. As shown in FIG. 12, in the optical metasurface structure 103, each of the metal rail structures RS may not include the first metal mask pattern described in the first embodiment, and the bonding pad BP may not include the second metal mask pattern described in the first embodiment. Therefore, the dielectric cap layer 60 may directly contact the top surface TS2 of the first copper pattern 46A in each of the metal rail structures RS and a top surface TS5 of the second copper pattern 46B in the bonding pad BP, the bottom surface of the bonding pad BP (such as the bottom surface BS4) and the bottom surface of each of the metal rail structures RS (such as the bottom surface BS1) may be substantially coplanar, and the top surface of the bonding pad BP (such as the top surface TS5) and the top surface of each of the metal rail structures TS (such as the top surface TS2) may be substantially coplanar. Please refer to FIG. 5, FIG. 13, FIG. 14, and FIG. 12. In some embodiments, FIG. 13 may be regarded as a schematic drawing in a step subsequent to FIG. 5, but not limited thereto. As shown in FIG. 5 and FIG. 13, in some embodiments, the metal mask layer 48 may be removed by the patterning process 90, and each of the metal rail structures RS and the bonding pad BP formed by the patterning process 90 may not include the first metal mask pattern and the second metal mask pattern described above. The top width of the first copper pattern 46A (such as the width W4) may be regarded as the top width of the corresponding metal rail structure RS, the top surface TS2 of each of the first copper patterns 46A may regarded as the top surface of the corresponding metal rail structure RS, and the top surface TS5 of the second copper pattern may be regarded as the top surface of the bonding pad BP. As shown in FIG. 14 and FIG. 12, the dielectric cap layer 60 may be formed conformally on the sidewall and the top surface of each of the metal rail structures RS and the sidewall and the top surface of the bonding pad BP, and the opening OP in this embodiment may penetrate through the dielectric cap layer 60 located on the bonding pad BP in the vertical direction D1 and expose the second copper pattern 46B.

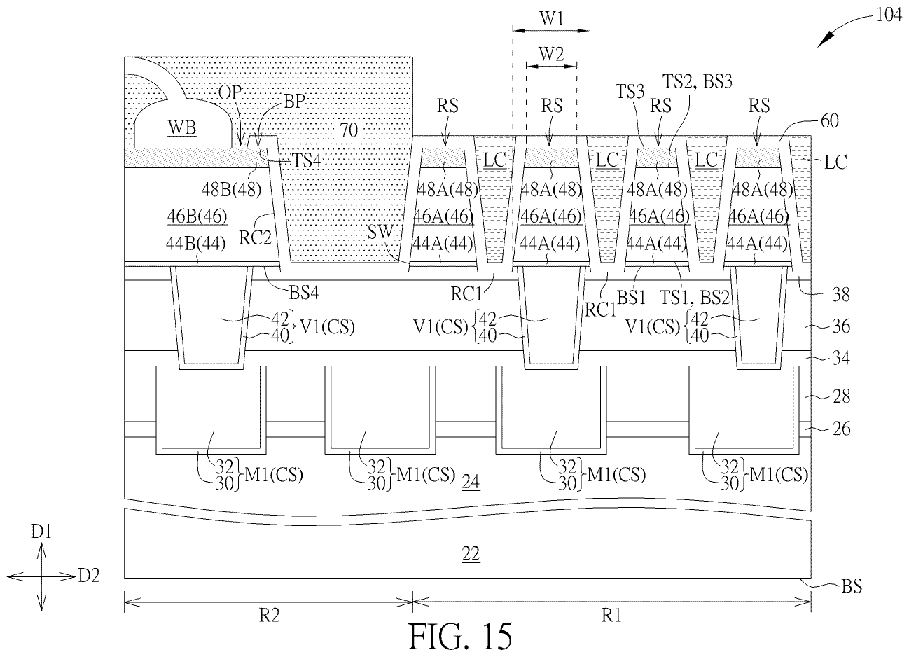

Please refer to FIG. 15. FIG. 15 is a schematic drawing illustrating an optical metasurface structure 104 according to a fourth embodiment of the present invention. Ass shown in FIG. 15, in the optical metasurface structure 104, the opening OP may penetrate through the dielectric cap layer 60 located on the bonding pad BP without penetrating through the second metal mask pattern 48B in the bonding pad BP, and the copper bonding wire WB may be disposed above the second metal mask pattern 48B and directly contact the top surface of the second metal mask pattern 48B.

To summarize the above descriptions, in the optical metasurface structure and the manufacturing method thereof according to the present invention, the combination of the metal rail structure with the top width less than the bottom width and the liquid crystal material may be used to realize the tunable optical metasurface structure. In addition, the metal rail structures and the bonding pad may be formed concurrently by the same process for process simplification and/or manufacturing cost reduction.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical metasurface structure, comprising:
a substrate comprising a first region and a second region;
metal rail structures disposed above the first region; and
a liquid crystal material disposed above the first region, wherein at least a part of the liquid crystal material is located between the metal rail structures adjacent to each other in a horizontal direction, and a top width of one of the metal rail structures is less than a bottom width of the one of the metal rail structures.

2. The optical metasurface structure according to claim 1, wherein each of the metal rail structures comprises:
a first barrier pattern; and
a first copper pattern disposed on the first barrier pattern, wherein a top width of the first copper pattern is less than a bottom width of the first copper pattern.

3. The optical metasurface structure according to claim 2, wherein each of the metal rail structures further comprises:
a first metal mask pattern disposed on the first copper pattern, wherein a top width of the first metal mask pattern is less than a bottom width of the first metal mask pattern.

4. The optical metasurface structure according to claim 2, further comprising:
a dielectric cap layer disposed on the metal rail structures, wherein a part of the dielectric cap layer is sandwiched between the liquid crystal material and each of the metal rail structures, and the dielectric cap layer is disposed on and directly contacts a sidewall of the first barrier pattern of each of the metal rail structures.

5. The optical metasurface structure according to claim 1, further comprising:
a bonding pad disposed above the second region, wherein a material composition of the bonding pad is identical to a material composition of each of the metal rail structures.

6. The optical metasurface structure according to claim 5, wherein a bottom surface of the bonding pad and a bottom surface of each of the metal rail structures are coplanar, and a top surface of the bonding pad and a top surface of each of the metal rail structures are coplanar.

7. The optical metasurface structure according to claim 5, further comprising:
a dielectric cap layer disposed on the metal rail structures and the bonding pad, wherein a part of the dielectric cap layer is sandwiched between the liquid crystal material and each of the metal rail structures.

8. The optical metasurface structure according to claim 7, wherein the bonding pad comprises:
a second barrier pattern; and
a second copper pattern disposed on the first barrier pattern.

9. The optical metasurface structure according to claim 8, wherein the bonding pad further comprises a second metal mask pattern disposed on the second copper pattern, and the optical metasurface structure further comprises:
an opening penetrating through the dielectric cap layer on the bonding pad and the second metal mask pattern; and
a copper bonding wire partly disposed in the opening and directly connected with the second copper pattern.

10. The optical metasurface structure according to claim 5, further comprising:
a dielectric layer disposed on the first region and the second region of the substrate; and
a connection structure disposed in the dielectric layer, wherein the bonding pad and the metal rail structures are disposed above the dielectric layer and the connection structure, and the bonding pad is electrically connected with at least one of the metal rail structures via the connection structure.

11. A manufacturing method of an optical metasurface structure, comprising:
providing a substrate comprising a first region and a second region;
forming metal rail structures above the first region; and
forming a liquid crystal material above the first region, wherein at least a part of the liquid crystal material is located between the metal rail structures adjacent to each other in a horizontal direction, and a top width of one of the metal rail structures is less than a bottom width of the one of the metal rail structures.

12. The manufacturing method of the optical metasurface structure according to claim 11, further comprising:
forming a bonding pad above the second region, wherein a material composition of the bonding pad is identical to a material composition of each of the metal rail structures, and the bonding pad and the metal rail structures are formed concurrently by the same process.

13. The manufacturing method of the optical metasurface structure according to claim 12, wherein a method of forming the bonding pad and the metal rail structures comprises:
forming a barrier material layer on the first region and the second region of the substrate;
forming a copper layer on the barrier material layer; and
performing a patterning process, wherein the barrier material layer is patterned to be a patterned barrier layer by the patterning process, and the copper layer is patterned to be a patterned copper layer by the patterning process,
wherein the patterned barrier layer comprises first barrier patterns located above the first region and a second barrier pattern located above the second region, the patterned copper layer comprises first copper patterns located above the first region and a second copper pattern located above the second region, each of the metal rail structures comprises one of the first barrier patterns and one of the first copper patterns, and the bonding pad comprises the second barrier pattern and the second copper pattern.

14. The manufacturing method of the optical metasurface structure according to claim 13, wherein the patterning process comprises an ion beam etching (IBE) process.

15. The manufacturing method of the optical metasurface structure according to claim 13, wherein a top width of one of the first copper patterns is less than a bottom width of the one of the first copper patterns.

16. The manufacturing method of the optical metasurface structure according to claim 13, wherein the method of forming the bonding pad and the metal rail structures further comprises:
forming a metal mask layer on the copper layer before the patterning process, wherein the metal mask layer is patterned to be a patterned metal mask layer by the patterning process, the patterned metal mask layer comprises first metal mask patterns located above the first region and a second metal mask pattern located above the second region, each of the metal rail structures further comprises one of the first metal mask patterns, and the bonding pad further comprises the second metal mask pattern.

17. The manufacturing method of the optical metasurface structure according to claim 16, wherein a top width of one of the first metal mask patterns is less than a bottom width of the one of the first metal mask patterns.

18. The manufacturing method of the optical metasurface structure according to claim 16, further comprising:
forming a dielectric cap layer on the metal rail structures and the bonding pad before liquid crystal material is formed, wherein a part of the dielectric cap layer is sandwiched between the liquid crystal material and each of the metal rail structures.

19. The manufacturing method of the optical metasurface structure according to claim 18, further comprising:
forming an opening penetrating through the dielectric cap layer on the bonding pad and the second metal mask pattern; and
forming a copper bonding wire on the bonding pad, wherein the copper bonding wire is partly disposed in the opening and directly connected with the second copper pattern.

20. The manufacturing method of the optical metasurface structure according to claim 12, further comprising:
forming a dielectric layer on the first region and the second region of the substrate before the bonding pad and the metal rail structures are formed; and
forming a connection structure in the dielectric layer before the bonding pad and the metal rail structures are formed, wherein the bonding pad and the metal rail structures are formed above the dielectric layer and the connection structure, and the bonding pad is electrically connected with at least one of the metal rail structures via the connection structure.
